(19) United States
(12) Patent Application Publication
(10) Pub. No.: US 2004/0056905 A1
(43) Pub. Date: Mar. 25, 2004

(54) System and method for commerce and exposure on the internet

(76) Inventor: Keith R. Lawrence, Cincinnati, OH (US)

Correspondence Address: BAKER & HOSTETLER LLP, Washington Square, Suite 1100, 1050 Connecticut Avenue, N.W., WASHINGTON, DC, 20036, US

(21) Appl. No.: 10/247,533

(22) Filed: Sep. 20, 2002

(51) Int. Cl. G09G 5/00

(52) U.S. Cl. 345/854; 345/767

(57) ABSTRACT

A system and method of commerce over a distributed network is provided. A portal allows a user to link with other computers on the Internet and navigate through drop down menus. The portal having a display of merchants that allows user to more readily identify relevant merchants.

### FIELD OF THE INVENTION

The present invention relates generally to a system and method for commerce over a distributed network. More particularly, the present invention allows a user to find web sites that provide goods, services, and information over a distributed network, such as the Internet.

### BACKGROUND OF THE INVENTION

Currently, there are more than 23 million web sites on the Internet that serve more than 513 million people. The web sites belong to online merchants, companies, organizations, government agencies, individual home pages, etc. With the vast number of available web sites, a typical user has about ten to fifteen “bookmarks” of favorite web sites. While some of these can be bookmarks for web sites of various retailers of goods and services, it clearly would not be possible to bookmark for all products. For example, if a user is looking for a screwdriver set, his “bookmarks” may contain web sites of online merchants that sell general products, but do not carry the best price or selection of screwdriver sets. Other web sites that specialize in screwdriver sets are available on the Internet but, because users often get frustrated when looking for web sites, they frequently settle for web sites that sell general merchandise.

Even for a sophisticated user, finding a product from an online merchant can be taxing with a search engine, such as Yahoo™ or Google™. Search engines regularly return thousands of web sites for merchants that sell that particular product and return hundreds of web sites that are not relevant to the search. For example, in one search for “basketball” on the Internet, the search returned more than 9,590,000 web sites. A further refinement of that search to “buy basketball” still returned more than 793,000 web sites. Because the user has to review each web site individually for relevancy, it can be time consuming and frustrating for the user when shopping for goods and services on the Internet. Additionally, the user has to come up with the right keywords for a search in order to narrow the number of returned web sites.

For merchants who are online with their web sites, getting the necessary traffic to sell their information, products or services can also be difficult. The cost for an online merchant to maintain a web site can be expensive, especially for a small merchant. Often the merchant does not have the expertise to properly market their web sites to the user and have to rely on search engines to display their web sites. However, as stated above, when the site is located in a search, the merchant web site can be part of a long list of other merchants that sell similar information, products or services. In order to increase traffic to their web sites, the online merchants often have to pay expensive listing fees on search engines so that their web site will be one of the first listed in the search results. Even after paying the high fees, the merchant can still be listed among hundreds of merchants that sell the same products or services.

Therefore, there is a need for a system and method for simplifying the search for products, services, and information on the Internet by users that also allows more visibility for a merchant.

### SUMMARY OF THE INVENTION

The embodiments of the present invention relate to searching, organizing, cataloging, and conducting business on a distributed network, such as the Internet. The user is assisted through the embodiments of the invention to more easily and quickly search for information, services and goods on the Internet.

In one embodiment, a distributed network browser viewable interface that includes at least one search topic viewable on the interface and having at least one drop down button, at least one drop down menu actuated by the at least one drop down button, and at least one keyword is selectable from the drop down menu that when selected, a portion of the interface is highlighted. The interface can be a web page and the portion of the interface can include at least one linking member. The at least one linking member may include a logo of a merchant. The at least one linking member can be linked to another interface. Additionally, the linking member can highlighted by changing the color of the linking member, bolding the linking member, flashing of the linking member, raised lettering of the linking member, the linking member's border changing in color, inserting a bullet, graphic or icon before the linking member, the linking member appears in another interface, other changes that distinguishes that portion of the interface, and a combination thereof.

A distributed network browser viewable interface is provided and can include a drop down menu having at least one selectable keyword, at least one linking member in a first position, and at least one linking member in a second position, wherein the at least one linking members are rotated between the positions at a predetermined time. The interface can further include an actuating button, at least one linking member in a third position, and at least one linking member in a fourth position, wherein the at least one linking members can be rotated between the first, second, third and fourth positions at a predetermined time. The at least one linking member can link to another interface, can include a logo of a merchant or can include a name of a merchant. Additionally, when the keyword can be selected, at least one of the at least one linking members can be highlighted by changing the color of the linking member, bolding the linking member, flashing of the linking member, raised lettering of the linking member, the linking member's border changing in color, inserting a bullet, graphic or icon before the linking member, the linking member appears in another interface, other changes that distinguishes that portion of the interface, and a combination thereof. The predetermined time can be selected from every time the interface is accessed, about 1 minute to about one hour, about every hour, about every day, about every other day, about every week, about every month, about any other time period, or a combination thereof. When the keyword is selected, another interface may be actuated and the actuating button may actuate the at least one linking member to display a temporary window. The actuating button can actuate the drop down menu to drop down. The first and second positions can be columns on the interface. The third position can be located between the first and second positions and can include from about 9 to about 15 linking members. Each of the first and second positions can include from about 20 to about 30 linking members. The linking members on the interface may never rotate or can be changed when a new linking member is added or removed.

In another embodiment, a method of browsing on a distributed network can include selecting a drop down menu provided on a distributed network browser interface, wherein the drop down menu can have a keyword, selecting the keyword from the drop down menu, generating a response to the selection of the keyword, wherein the response can actuate another interface or direct the interface to another interface, and selecting a second keyword from the drop down menu so that a relevant portion of the interface is highlighted.

In still another embodiment, a method of browsing on a distributed network can include selecting a drop down menu provided on a distributed network browser interface, wherein the drop down menu has a keyword, selecting the keyword from the drop down menu, and generating a response to the selection of the keyword so that a relevant portion of the interface may be highlighted. The portion of the interface can be a linking member. Highlighting can be changing the color of the linking member, bolding the linking member, flashing of the linking member, raised lettering of the linking member, the linking member's border changing in color, inserting a bullet, graphic or icon before the linking member, the linking member appears in another interface, other changes that distinguish that portion of the interface, and a combination thereof. The relevant portion of the interface highlighted can direct the browser to another relevant interface based on the keyword selection. The relevant portion of the interface can be a linking member that links to another interface that is relevant to the keyword.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram representing a preferred embodiment of the present system and method.

FIG. 2 is a screen shot of an exemplary home page constructed in accordance with a preferred embodiment of the present invention.

FIG. 3. is an example of a screen shot with a drop down menu actuated.

FIG. 4 is a screen shot of a web page constructed in accordance with the system and method of the present invention.

FIG. 5 is a screen shot of a user selecting from a drop menu according to one embodiment of the present invention.

FIG. 6 is a screen shot of an example of highlighting.

FIG. 7 is a screen shot of a web page having an actuated pop-up window.

FIG. 8 is a screen shot of a user linking to another web page according to one embodiment of the present invention.

### DETAILED DESCRIPTION OF THE PREFERRED EMBODIMENT

The present invention provides a system and method for interacting with a distributed network, such as the Internet or the world wide web, for locating web sites that provide information, products, and services. The Internet, as used herein, is a collection of linked networks that communicate through a set standard protocol, such as TCP/IP. The world wide web, as used herein, is linked, web browser viewable, documents (hypertext) or web pages that are accessed by the Internet. HTTP (hypertext transport protocol) is the protocol typically used for accessing web pages. HTTP is the accepted protocol used to exchange information, such as a web page, between a web browser and a web server. The web pages are encoded using codes, such as HTML (hypertext markup language). HTML is an accepted convention of codes for providing attributes within the web pages, including linking to other web pages. Once the HTML codes are created and uploaded to a web server, a web browser can display the information based on the embedded HTML. A person skilled in the art will recognize that the invention can be practiced with other programming languages, such as ASP (Active Server Pages), JSP (Java Server Page), SQL (Structure Query Language), JAVA, CGI (Computer Gateway Interface) and other languages. The web pages and the associated files are stored at a location defined by a URL (uniform resource locator), which has a unique IP (Internet protocol) address, such as 271.44.25.345. The typical URL format is protocol://machine address:port/path/filename. The port is not required to be entered because the web browser can use a default port, if one is not provided. A user types in the URL in order to access the desired web page, but a domain name server (“DNS”) interprets the URL into the correct IP address. For example, a user who wishes to reach the U.S. Patent and Trademark Office (“PTO”) will type into the input portion of the web browser the following URL to access the PTO's web site, namely http://www.uspto.gov where they will reach the PTO's home page because the DNS converted the URL into the PTO's IP address. Typically, users and merchants will access the Internet via an Internet Service Provider (“ISP”), such as AOL™, Earthlink™, etc.

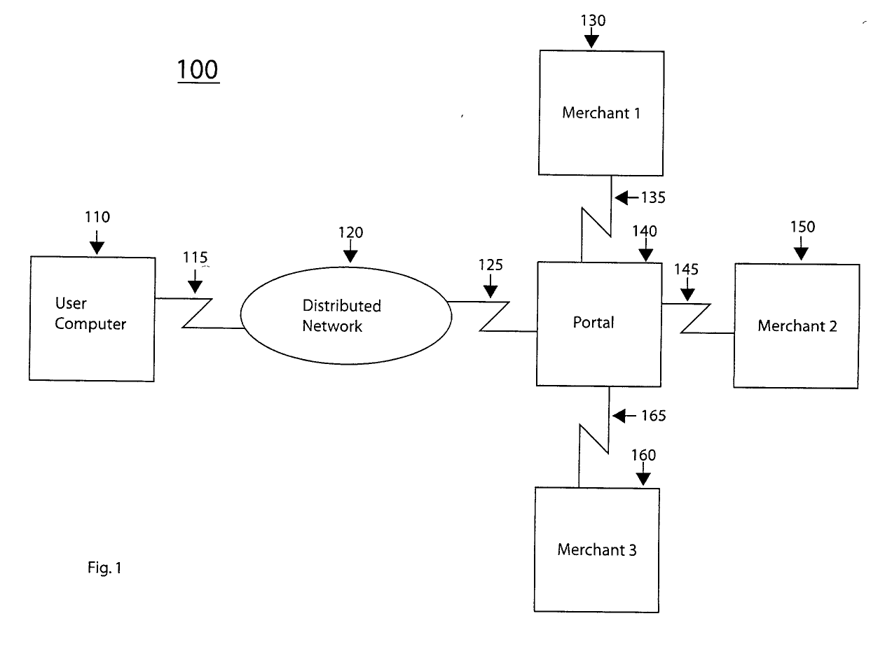

FIG. 1 is a block diagram representing a preferred embodiment of the present system and method. The system 100 can include a user computer 110, a distributed network 120, such as the Internet or the world wide web, a portal 140, a first merchant 130, a second merchant 150, and a third merchant 160. It should be understood that the system depicted in FIG. 1 is intended to be exemplary. There can be an unlimited number of merchants that could be linked to an unlimited number of portals 140.

Typically, the user uses the user's computer 10, which connects to the Internet 120 via the ISP, where a web browser loaded on the user's computer, such as Internet Explorer™ or Netscape™, accesses the Internet. A first communication link 115 connects the user's computer 110 to the Internet 120. The Internet 120, the user's computer 110, and the merchant computers 130, 150 and 160 are linked and communicate through the standard protocol, such as TCP/IP, and can form the distributed network. A person skilled in the art will recognize that the standard protocol can be any protocol that allows communication in the system 100. The Internet 120 is linked to the portal 140 via a second communication link 125. The portal 140 is connected to the first merchant 130 via a third communication link 135, to the second merchant 150 via a fourth communication link 145, and to the third merchant 160 via a fifth communication link 165.

The merchants 130, 150, and 160 can be any merchant that provides services, goods, and information. Examples of services include consulting services, legal services, tax preparation services, catering services, travel related services, and any other services the user may want. Examples of goods include basketballs, shoes, clothing, DVDs, CDs, automotive products, computer supplies and equipment, office supplies, and any other goods that the user may want. Examples of information and topics include business and economy, government, health, home and garden, news, references, science and technology, social sciences, society and culture, education, and other information and topics that a user may want.

By connecting through the Internet 120, the user can connect to the portal 140, where the user can follow links to view the merchant's web sites that provide the desired goods, services, and information. The portal 140 has its own IP address and includes web pages that have a variety of information and functions.

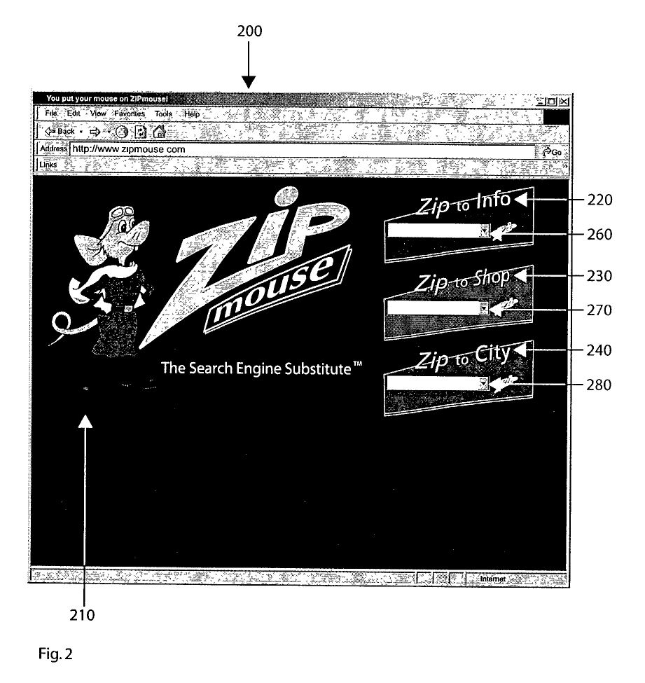

As shown in FIG. 2, one such function is to provide a home page 200, which is a start web page and is typically the first web page at the designated URL that the user will encounter. The home page 200 can provide information, such as information about the company, the services, goods and topics that the user is searching for and links to other web pages.

FIG. 2 is a screen shot of an exemplary home page 200 with drop down menu buttons 260, 270, and 280 constructed in accordance with a preferred embodiment of the present invention. The portal 140 has the home page 200 that includes a name or logo 210 of the home page, such as Zipmouse™ and the Search Engine Substitute™, and one, two, or preferably three or more search categories 220, 230, and 240. The categories can be information 220, shopping 230, city 240, and other categories, as desired.

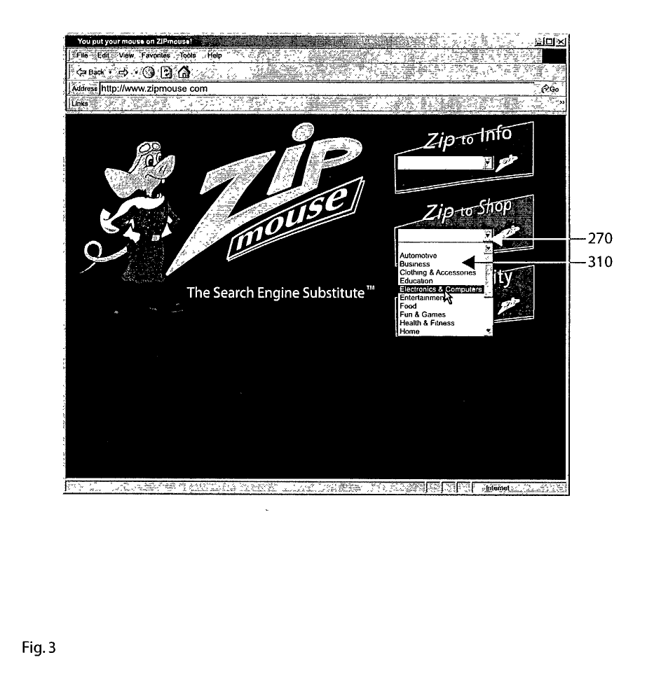

The shopping category 230 has a drop down menu button 270 that drops down a menu 310 or a navigational construct (See FIG. 3) with different topics. The drop down menu is a standard HTML (or other program language) within the <FORM> tag or specifically, the <SELECT> tag. Examples of topics under the shopping category 230 include automotive, business, clothing and accessories, computers and electronics, education, entertainment, food, fun and games, health and fitness, home, internet, kids, pets, sports, travel, wedding, and many others.

The information category 220 can provide links to other web pages that can be accessed by “clicking” the drop down menu button 260, which also drops down a menu (not shown). Examples of topics under the drop down menu of the information category 220 are arts and humanities, education, government, health, news, reference, science and technology, social science, society and culture, sports and recreation, and many others.

The city category 240 has a drop down menu button 280, which also drops down a menu(not shown). Examples of cities under the city category 240 include Atlanta, Boston, Charlotte, Chicago, Cincinnati, Cleveland, Dallas, Denver, San Antonio, and other cities.

In one embodiment, the individual city web page will contain merchants that are geographically located in that city, so that the user can order the product or service online, and can pick up the order or have the service rendered in that city. As an example, the user can order a basketball from a sporting good store who is a merchant on that city's web page, pay for it online and pick it up from the sporting good store itself. Because the merchant is in the same city as the user, the user can pick up the merchandise at the store right away, so that no shipping charge is assessed, and no waiting time is required for delivery of the basketball. Additionally, the user does not have to wait in line at the store to purchase the basketball and can proceed straight to the pick up line saving valuable time.

Many web pages have keyword search engines so that users can locate items in a web site. The keyword search requires the user to input the search terms or keywords related to what the user is searching for. However, if the correct keyword is not used, the search can return irrelevant items that the user must wade through in order to get to the relevant items. By having drop down menus 310 with keywords, the user is given the relevant keywords that will yield the most pertinent results from the search. The drop down menus 310 are designed to provide as many keywords as needed per category or per topic, so that the user does not have to think about keywords to use.

In a preferred embodiment, the user will start at the home page 200 and navigate the various web pages that are linked to the home page through the use of drop down menus 310. Additionally, for people who can not type, the drop down menu 310 provides a quick and easy way to navigate the Internet without having to input the keywords and leaves the user with a better shopping experience. It should be noted that there can be as many drop down buttons 260, 270 and 280 and drop down menus 310, as needed. Additionally, keyword, as used herein, can include words, symbols, a logo or other things, as long as the user knows what it means.

FIG. 3. is an example of a screen shot with the drop down menu 310 actuated. In this example, the user wants to shop for an electronic product and has clicked on the drop down menu button 270. The drop down menu 310 is dropped down and displays keywords, such as electronics & computers. The user can select the keywords from the drop down menu 310 by moving a mouse cursor to the desired keyword. A new web page or interface may launch or the current web page may be directed to another web page.

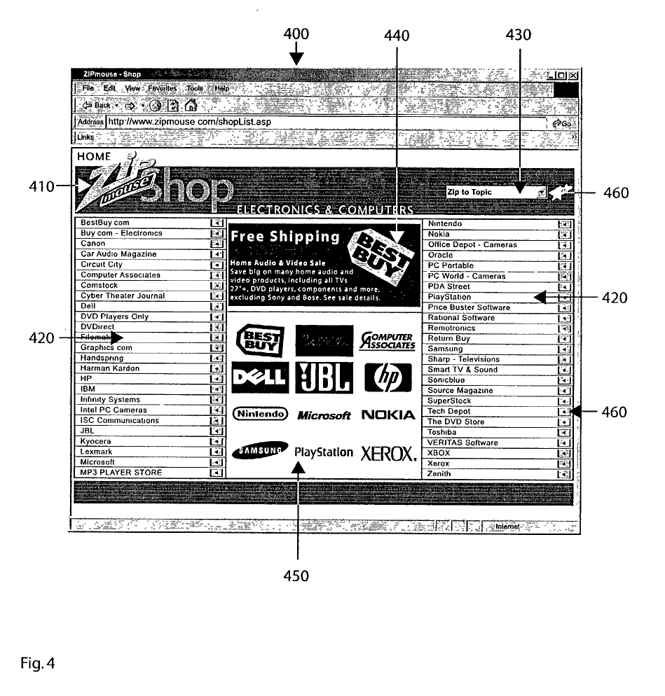

FIG. 4 is a screen shot of a web page 400 constructed in accordance with the system and method of the present invention. This web page 400 may appear, after the user selects electronics & computers in FIG. 3. In one embodiment, the web page 400 includes a logo 410 and a drop down menu 430 at the top portion, at least one but preferably two or more columns 420 flanking the left and right portions of the web page, a first middle portion 440 that displays one merchant, and a second middle portion 450 that displays various merchants between the two columns 420, and a drop down menu button 460 located next to the merchant's name or logo or next to the drop down menu 430. It will be understood by a person skilled in the art that the logo 410, the drop down menu 430, the columns 420, the first and second middle portions 440, 450, and the drop down menu button 460 can be located anywhere on the web page 400.

The logo 410 can be any logo that is desired. The logo 410 can be related to the topic, category, or information of the web page 400. The drop down menu 430 can have any topics or keywords that pertain to the merchants on the web page 400, can allow the web page to return to the home page 200 or can link the user to additional web pages depending on the keyword. It will be recognized that logo, as used herein, can include a design and/or a slogan. Additionally, the logos used herein are for illustrative purposes only.

Still referring to FIG. 4, the columns 420 contain at least one, preferably ten, more preferably 20 and even more preferably 25 merchants per column. It will be recognized by a person skilled in the art that there is no limit as to the amount of merchants that can be listed in the column 420. However, by limiting the number of merchants per web page, the user can find the merchants more readily and allows the merchants to be displayed with a limited number of other merchants. The merchants can be shown on the column 420 by name or by the corresponding logo which is linked to that merchant's web site. If the user wants to go to that merchant's web page, he can “click” on the merchant's name or logo and the current web page will be directed to that merchant's web page or that merchant's web page will be launched as a new web page and the current web page will remain.

In a preferred embodiment, the merchants in columns 420 can rotate so that each merchant can have equal access to each part of the columns. The rotation can be ordered or randomly selected and can be based on certain events or time periods, such as every time the web page is accessed, 1 minute, every hour, every day, every other day, every week, every month, other time period, or a combination thereof, so long as each merchant has about equal access to each part of the columns 420. For example, the merchant can start at number twenty on the columns 420 in the first week, then move up the columns one spot per week to number nineteen and so on, until the merchant reaches the number one spot.

In an alternative embodiment, the merchants do not rotate. The merchants may remain in their position on the web page or may change when the merchant is removed (for example, non-payment or changed to another position by paying a higher fee, etc.), replaced or added with another merchant(s).

The first middle portion 440 displays the merchant's logo along with an ad related to the merchant's goods, services or information about the merchant. However, an ad is not required to be with the merchant's logo or name. The first middle portion 440 provides the merchant a greater exposure to the user than the space provided by the columns 420 and the second middle column 450. In a preferred embodiment, the first middle portion 440 rotates with different merchants. The rotations can include the merchants on columns 420 or the second middle portion 450. The time period can be the same as the time period to rotate the merchants on columns 420 (as discussed herein), can be another time period, or the merchants do not rotate (as discussed herein). By rotating the merchants that are displayed in the first middle portion 440, every merchant on the same web page 400 can be provided equal exposure.

Still referring to FIG. 4, the second middle portion 450, displays at least one, preferably six, and more preferably twelve or more merchants. The merchants' location can rotate, as discussed herein, or can remain the same. By having a smaller amount of merchants than columns 420, the merchants in the second middle portion 450 are more readily recognized and are likely to draw more traffic.

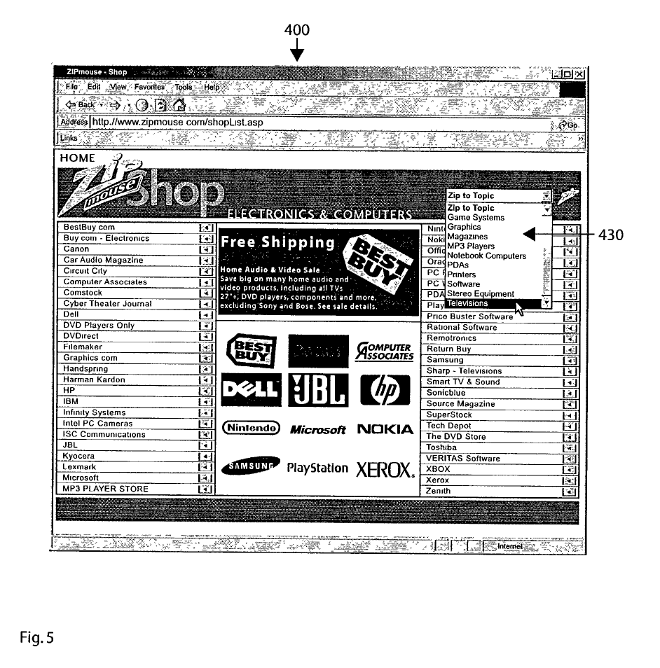

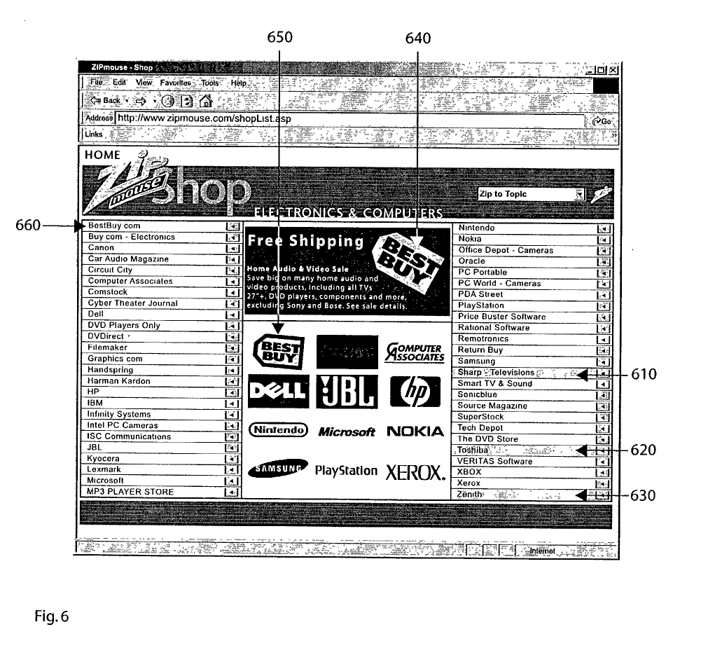

In a preferred embodiment, the drop down menu 430 includes keywords that will match various merchants at that particular web page 400. As shown in FIG. 5 and 6, if the user selects televisions from the drop down menu 430, approximately 2-4 merchants that sell televisions will be “highlighted,” such as Sharp® 610, Toshiba® 620, and Zenith® 630. In an another embodiment, a merchant that matched with televisions, for example, such as Best Buy® 640, 650 and 660, can be highlighted in any or all of the locations in which the merchant is located on the web page or interface. For example, in any of the columns 420, the first middle portion 440, and the second middle portion 450. Examples of “highlighted” include having the merchants on the columns 420, and/or the first and second middle portions 440, 450 change in color or their listing dropped into another web page. Other forms of highlighting include raised lettering, borders changing in color, bolding logo, flashing of the logo, inserting a bullet point, graphic or icon, or any other change that will temporarily distinguish the merchant from the other merchants on the web page. The colors can include yellow, orange, blue, pink, any other color, or a combination thereof.

As will be readily understood, the web page 400 operates as an Internet Directory featuring a limited number of, preferably, unrelated merchants. Merchants would be charged a subscription fee in order to be featured on the Internet Directory. Given the relative size of the portion of the web page on which a merchant's advertising is displayed, merchants featured in the first middle portion 440 will draw more traffic than those featured in the second middle portion 450. Similarly, merchants featured in the second middle portion 450 will draw more traffic than those featured in the columns 420.

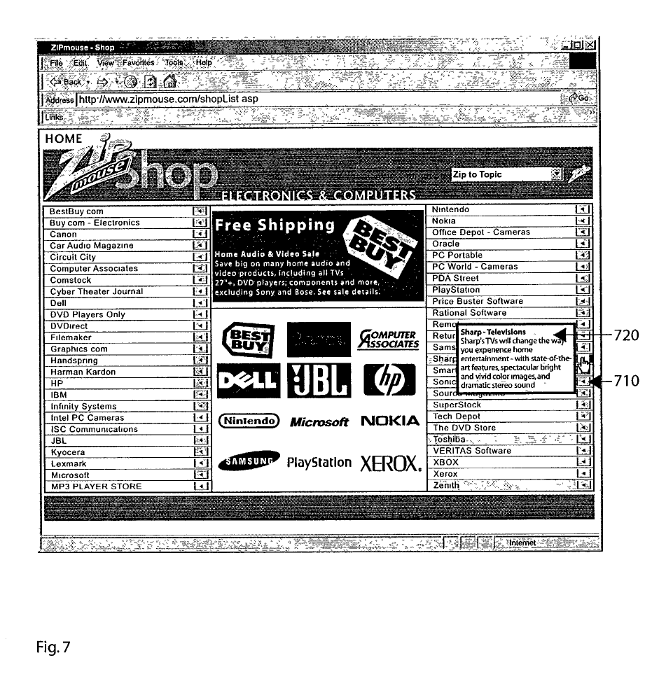

FIG. 7 illustrates an embodiment of pop-up button 710 and windows 720 in accordance with a preferred embodiment of the present invention. The pop-up buttons 710 are located next to the name or logo of the merchant so that a pop-up window 720 having a short synopsis of the merchant is shown to the user. In one embodiment, the pop-up window 720 can contain information about the merchant, such as what services it provides or what goods are sold by the merchant. In another embodiment, the pop-up window 720 can contain information about the merchant, such where it is located, its history, and how long it has been in business. In still another embodiment, the pop-up window 720 can contain any additional information the merchant desires to provide. There can be any number of pop-up buttons 710 and windows 720 and any desired information can be displayed.

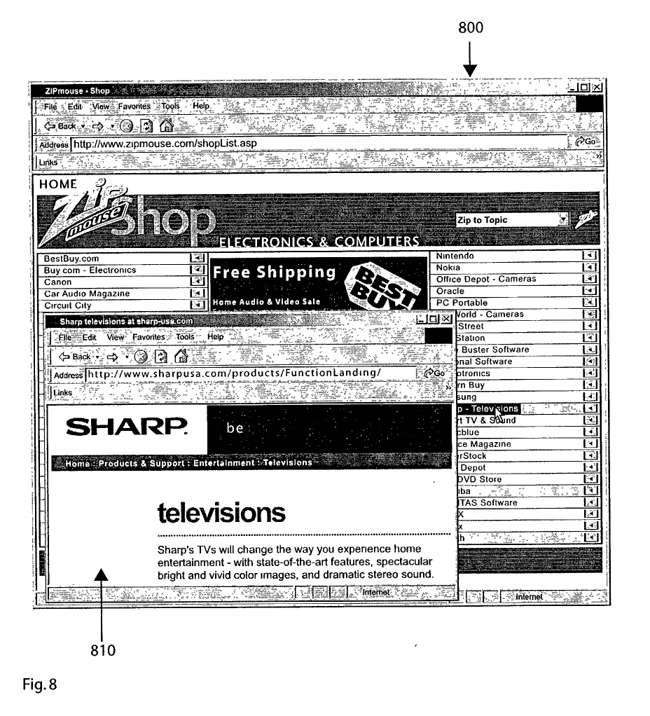

When the desired merchant is chosen, in one embodiment, the user can click on the merchant's name and a new web page 810, which is the merchant's web page can appear, as shown in FIG. 8. Although a new web page 810 appears, the original web page 800 can still be active and the user can pick another store, should the user not like the price or the products offered or continue to browse for other stores and additional information.

The fee for being featured on the web page can be determined by location on the web page, with those occupying prime web page “real estate” paying higher fees. Other fee arrangements can also be created with merchants being offered the option of being featured in certain locations at certain times of the day for set fees. It should be understood that any permutation of location and time of featuring on the web site, including the rolling displays described above, can be used to set fees for merchants.

The Internet Directories of the present invention provides significant advantages to both users and merchants. In an implementation in which a number of competing merchants are linked to the same site, users benefit by having a single point from which to launch a comparative shopping search. In fact, in an embodiment of the invention, the site is provided with a search engine for comparing prices for the products of the featured merchants. In an implementation in which the merchants are not competing, users benefit from having a single location from which they can browse similar to how they would browse in a physical mall.

Merchants also benefit from inclusion on the Internet Directory. In the implementation in which multiple competing merchants are included in the Directory, the inclusion of numerous related merchants will result in more traffic to the site by users looking for the information, products or services offered by the merchant. In the implementation in which the merchant is included with non-competing merchants, the merchant would benefit from the traffic to the site by users with a general interest in purchasing products or services. In either implementation, a portion of the fees paid by each merchant could be used for advertising by the Internet Directory web site thus, smaller merchants would benefit from a larger advertising budget.

It should be recognized that many Internet Directory focusing on different information, products or services could be created and operated by a single entity. A first web site could then be accessed that would contain a drop down menu identifying the different information, products or services available in different ones of the Internet Directories. By selecting a particular information topic, product or service from the drop down menu, the user would be directed to the relevant Internet Directory. The advantage of such an approach is the increased advertising dollars available to draw traffic to the main page and thus, to the individual Internet Directory.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed:

1. A distributed network browser viewable interface, comprising:
at least one search topic viewable on the interface and having at least one drop down button;
at least one drop down menu actuated by the at least one drop down button; and
at least one keyword is selectable from the drop down menu that when selected, a portion of the interface is highlighted.

2. The interface of claim 1, wherein the interface is a web page.

3. The interface of claim 1, wherein the portion of the interface includes at least one linking member.

4. The interface of claim 3, wherein the at least one linking member includes a logo of a merchant.

5. The interface of claim 4, wherein the at least one linking member is linked to another interface.

6. The interface of claim 3, wherein highlighted is selected from a group consisting of changing the color of the linking member, bolding the linking member, flashing of the linking member, raised lettering of the linking member, the linking member's border changing in color, inserting a bullet, graphic or icon before the linking member, the linking member appears in another interface, other changes that distinguishes that portion of the interface, and a combination thereof.

7. A distributed network browser viewable interface, comprising:
a drop down menu having at least one selectable keyword;
at least one linking member in a first position; and
at least one linking member in a second position, wherein the at least one linking members are rotated between the positions at a predetermined time.

8. The interface of claim 7, further comprising:
an actuating button;
at least one linking member in a third position; and
at least one linking member in a fourth position, wherein the linking members are rotated between the first, second, third and fourth positions at a predetermined time.

9. The interface of claim 8, wherein the at least one linking member links to another interface.

10. The interface of claim 8, wherein the at least one linking member includes a logo of a merchant.

11. The interface of claim 8, wherein the at least one linking member includes a name of a merchant.

12. The interface of claim 8, wherein when the keyword is selected, at least one of the at least one linking members is highlighted.

13. The interface of claim 12, wherein highlighted is selected from a group consisting of changing the color of the linking member, bolding the linking member, flashing of the linking member, raised lettering of the linking member, the linking member's border changing in color, inserting a bullet, graphic or icon before the linking member, the linking member appears in another interface, other changes that distinguishes that portion of the interface, and a combination thereof.

14. The interface of claim 7, wherein the predetermined time is selected from a group consisting of 1 minute, every hour, every day, every other day, every week, every month, any other time period, or a combination thereof.

15. The interface of claim 7, wherein when the keyword is selected, another interface is actuated.

16. The interface of claim 8, wherein the actuating button actuates the at least one linking member to display a temporary window.

17. The interface of claim 8, wherein the actuating button actuates the drop down menu to drop down.

18. The interface of claim 7, wherein the first and second positions are columns on the interface.

19. The interface of claim 8, wherein the third position is located between the first and second positions and includes from 9 to 15 at least one linking members.

20. The interface of claim 7, wherein each of the first and second positions include from 20 to 30 at least one linking members.

21. The interface of claim 8, wherein the predetermined time is changing of a linking member from the interface.

22. The interface of claim 8, wherein the predetermined time can be selected from a group consisting of when the linking member is removed, when the linking member is added or a combination thereof.

23. A method of browsing on a distributed network, comprising:
selecting a drop down menu provided on a distributed network browser interface, wherein the drop down menu has a keyword;
selecting the keyword from the drop down menu;
generating a response to the selection of the keyword, wherein the response is actuating another interface or directing the interface to another interface; and
selecting a second keyword from the drop down menu so that a relevant portion of the interface is highlighted.

24. A method of browsing on a distributed network, comprising:
selecting a drop down menu provided on a distributed network browser interface, wherein the drop down menu has a keyword;
selecting the keyword from the drop down menu; and
generating a response to the selection of the keyword so that a relevant portion of the interface is highlighted.

25. The method of claim 24, wherein the portion of the interface is a linking member.

26. The method of claim 24, wherein highlighted is selected from a group consisting of changing the color of the linking member, bolding the linking member, flashing of the linking member, raised lettering of the linking member, the linking member's border changing in color, inserting a bullet, graphic or icon before the linking member, the linking member appears in another interface, other changes that distinguishes that portion of the interface, and a combination thereof.

27. The method of claim 24, wherein the relevant portion of the interface that is highlighted includes directing the interface to another relevant interface based on the keyword selection.

28. The method of claim 24, wherein the relevant portion of the interface is a linking member that links to another interface that is relevant to the keyword.
